(19) United States
(12) Patent Application Publication
(10) Pub. No.: US 2025/0140788 A1
(43) Pub. Date: May 1, 2025

(54) ELECTRODE SLURRY DRYING DEVICE FOR SECONDARY BATTERY

(71) Applicant: SAMSUNG SDI CO., LTD., Yongin-si (KR)

(72) Inventors: Youngha JOO, Yongin-si (KR); Minku KIM, Yongin-si (KR); Junghoon LEE, Yongin-si (KR); Sangdon CHOI, Yongin-si (KR)

(21) Appl. No.: 18/587,765

(22) Filed: Feb. 26, 2024

(30) Foreign Application Priority Data
Oct. 30, 2023 (KR) 10-2023-0146838

(51) Int. Cl. H01M 4/23; F26B 17/02; F26B 21/00

(52) U.S. Cl. CPC H01M 4/23; F26B 17/023; F26B 21/004

(57) ABSTRACT

An electrode-slurry-drying device according to one or more embodiments of the present disclosure includes a nozzle configured to spray gas to dry an electrode slurry comprising a solvent applied on a substrate; and a nozzle plate at an outlet of the nozzle, and defining perforations for discharging the gas toward the substrate, wherein a number of the perforations is determined based on an amount of undried solvent on the substrate.

### CROSS-REFERENCE TO RELATED APPLICATION

The present application claims priority to and the benefit of Korean Patent Application No. 10-2023-0146838, filed on Oct. 30, 2023, in the Korean Intellectual Property Office, the entire disclosure of which is incorporated herein by reference.

### BACKGROUND

### 1. Field

The present disclosure relates to an electrode-slurry-drying device.

### 2. Description Of Related Art

Unlike primary batteries that are not designed to be recharged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (for example, home and/or utility scale power storage). A secondary battery generally includes an electrode assembly including a positive electrode and a negative electrode, a case accommodating the same, and electrode terminals connected to the electrode assembly. The secondary battery is manufactured through various types of processes. In an electrode process of a secondary battery manufacturing process, positive and negative electrodes of secondary batteries are manufactured by applying a slurry including an active material on a substrate and then drying the slurry. The slurry applied on the substrate is dried as the solvent constituting a part of the slurry is evaporated while passing through a dryer.

In this case, if slurry is unevenly dried according to a position on the substrate, a decrease the quality of the secondary battery due to migration of a binder may result. Uneven drying of the slurry may be caused by airflow distribution inside the dryer according to an internal structure and circulation method of the dryer, which reduces the speed of the electrode process. Therefore, it is desirable to design a drying device to solve such problems.

The above information disclosed in this Background section is for enhancement of understanding of the background of the present disclosure, and therefore, it may contain information that does not constitute related (or prior) art.

### SUMMARY

The present disclosure provides an electrode-slurry-drying device (e.g., for a secondary battery).

However, the technical problem to be solved by the present disclosure is not limited to the above problem, and other problems not mentioned herein, and aspects of the present disclosure that would address such problems, will be clearly understood by those skilled in the art from the description of the present disclosure below.

An electrode-slurry-drying device according to one or more embodiments of the present disclosure includes a nozzle configured to spray gas to dry an electrode slurry including a solvent applied on a substrate, and a nozzle plate at an outlet of the nozzle, and defining perforations for discharging the gas toward the substrate, wherein a number of the perforations is determined based on an amount of undried solvent on the substrate.

The nozzle plate may include a plate region including plate sub-regions, wherein respective numbers of ones of the perforations at the plate sub-regions is proportional to respective amounts of the undried solvent in regions of the substrate respectively corresponding to the plate sub-regions.

The respective numbers of the ones of the perforations may be determined by applying respective ratios that are proportional to the respective amounts of the undried solvent to a total number of candidate perforations in the plate sub-regions.

A first number of corresponding ones of the perforations formed in one of the plate sub-regions corresponding to a central portion of the substrate may be greater than a second number of corresponding others of the perforations formed in one of the plate sub-regions corresponding to an edge portion of the substrate.

Positions of the perforations may be selected to maintain substantially constant distances between the perforations.

The electrode slurry may be applied by a stripe-coating process, wherein the perforations are omitted from a portion of the nozzle plate corresponding to a region of the substrate omitting the electrode slurry.

Positions of the perforations may have a line-symmetrical pattern.

The electrode-slurry-drying device may further include a densimeter configured to calculate the amount of the undried solvent based on a change in density of the electrode slurry on the substrate for respective regions of the substrate.

The densimeter may correspond to a radiation-type sensor.

The electrode-slurry-drying device may further include a chamber including an inlet through which the substrate is configured to be pulled in, and an outlet through which the substrate is configured to be pulled out, and configured to dry the electrode slurry inside the chamber, wherein the nozzle is connected to the chamber, and is configured to spray the gas into the chamber, and wherein the amount of the undried solvent is determined based on the substrate pulled out of the outlet.

The nozzle plate may include a plate region including plate sub-regions, wherein an area of the perforations defined in the plate sub-regions is proportional to a corresponding amount of the undried solvent in a region of the substrate corresponding to the plate sub-regions.

The electrode-slurry-drying device may further include supply pipes configured to supply the gas to the nozzle, and configured to supply the gas according to different heat sources.

An electrode-slurry-drying method according to one or more embodiments of the present disclosure includes spraying gas for drying an electrode slurry including a solvent applied on a substrate through a nozzle plate provided at an outlet of a nozzle, measuring an amount of undried solvent on the substrate, and determining an arrangement of perforations formed in the nozzle plate based on the amount of the undried solvent.

The measuring of the amount of the undried solvent may include measuring, by a densimeter, the amount of the undried solvent based on a change in density of the electrode slurry that is formed on the substrate for respective regions of the substrate.

The densimeter may correspond to a radiation-type sensor.

The electrode-slurry-drying method may further include replacing the nozzle plate with a new nozzle plate having a determined number of perforations, and drying the electrode slurry by using the nozzle including the new nozzle plate.

The nozzle plate may include a plate region including plate sub-regions, wherein the determining of the arrangement of the perforations includes determining respective numbers of the perforations at the plate sub-regions to be proportional to respective amounts of the undried solvent in respective regions of the substrate corresponding to the plate sub-regions.

The determining the respective numbers of the perforations may include applying respective ratios proportional to the respective amounts of the undried solvent to a total number of candidate perforations in the plate sub-regions.

The determining of the arrangement of the perforations may include selecting positions of the perforations to maintain substantially constant distances between the perforations.

The spraying the gas may include spraying the gas supplied from at least one of supply pipes for supplying the gas according to different heat sources through the nozzle plate.

According to one or more embodiments of the present disclosure, an electrode slurry applied on a substrate may be dried substantially uniformly in a width direction.

According to one or more embodiments of the present disclosure, by controlling a flow of gas inside a dryer, a solvent may be dried substantially uniformly in the entire region of a substrate.

According to one or more embodiments of the present disclosure, the number of perforations may be determined by applying a ratio proportional to the amount of undried solvent to the total number of candidate perforations in the plate sub-region, and a flow rate of gas may be suitably controlled.

According to one or more embodiments of the present disclosure, the numbers of perforations per unit area may be different from each other between plate sub-regions, and the flow rate of gas discharged toward a substrate may be suitably controlled.

According to the present disclosure, by performing no perforation on a certain sub-regions of a nozzle plate, a large amount of heat is applied to a region where the electrode slurry is not applied, and it is possible to reduce or prevent the likelihood of a substrate folding phenomenon worsening due to heat shrinkage. However, aspects of the present disclosure are not limited to those

described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates a cross-section of an electrode-slurry-drying device for a secondary battery, according to one or more embodiments of the present disclosure;

FIG. 2 illustrates a nozzle plate according to one or more embodiments of the present disclosure;

FIG. 3 illustrates a flow of the gas discharged from a nozzle including the nozzle plate of FIG. 2 toward a substrate;

FIG. 4 illustrates a degree of drying of a substrate dried by using the nozzle including the nozzle plate of FIG. 2;

FIG. 5 illustrates a graph showing measured density of a slurry for each region on a substrate dried by using the nozzle including the nozzle plate of FIG. 2;

FIG. 6 illustrating a nozzle plate according to one or more embodiments of the present disclosure;

FIG. 7 illustrates a method of determining the number of perforations of a nozzle plate, according to one or more embodiments of the present disclosure;

FIG. 8 illustrates a flow of gas discharged from the nozzle including the nozzle plate of FIG. 6 toward a substrate;

FIG. 9 illustrates a graph showing measured density of slurry for each region on a substrate according to the type of nozzle plate;

FIG. 10 illustrates views of color maps associated with a density of slurry for each region on a substrate according to a type of nozzle plate; and

FIG. 11 illustrates a flowchart showing an electrode-slurry-drying method for a secondary battery, according to one or more embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section.

Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132 (a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as

being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In the present disclosure, “density for each region” may refer to a mass of a material applied/coated on a substrate per unit area of the substrate. For example, the density for each region may be calculated in mg/cm².

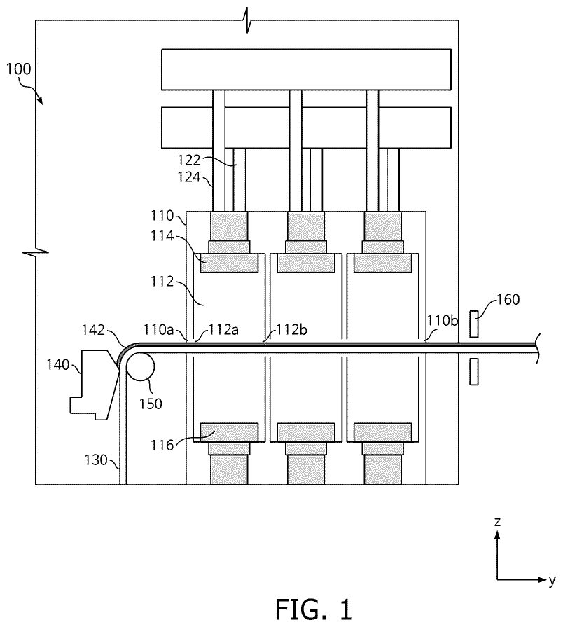

FIG. 1 illustrates a cross-section of an electrode-slurry-drying device 100 for a secondary battery, according to one or more embodiments of the present disclosure. Referring to FIG. 1, the electrode-slurry-drying device 100 may include a dryer 110, a chamber 112, a nozzle 114, a discharger 116, supply pipes 122 and 124, a roller 150, and a densimeter 160. The present disclosure is not limited thereto, and the electrode-slurry-drying device 100 may further include other components, or some components may be omitted.

A substrate 130 coated with an electrode slurry 142 may be pulled into the dryer 110 through a dryer inlet 110a, may be dried, and then may be pulled out of the dryer 110 through a dryer outlet 110b. The dryer 110 may be made of various materials and in various shapes, such as a rectangular shape, a cylindrical shape, and a multi-layered shape, and is not limited to the shape illustrated in FIG. 1.

The substrate 130 may be pulled into, or pulled out of, the dryer 110 while being moved by the roller 150. A movement direction of the substrate 130 may correspond to a +y direction. The roller 150 may rotate at a substantially constant speed to continuously pull the substrate 130 into and out of the dryer 110. The roller 150 may rotate for a first time to move the substrate 130, and then may stop the substrate 130 for a second time. The substrate may be dried in a movement state for the first time (e.g., first amount of time), and may be dried in a stop state for the second time (e.g., second amount of time). In other embodiments, the roller 150 may rotate continuously without stopping. In a state where the roller 150 continuously rotates without stopping, a rotation speed of the roller 150 may be relatively lower than a case where there is a stop time, and the substrate 130 may be dried while continuously moving.

Before the substrate 130 is pulled into the dryer 110 through the dryer inlet 110a, the electrode slurry 142 may be applied/coated on the substrate 130 by a coater 140. In this case, the electrode slurry 142 may be applied on the substrate 130 by a stripe-coating process in a direction of movement of the substrate 130.

The electrode slurry 142 applied on the substrate 130 may be formed by mixing an active material, a binder, and a conductive material by using a solvent. The active material included in the electrode slurry 142 may change depending on the type of an electrode being made. For example, an electrode slurry for making a positive electrode may include a positive electrode active material, such as lithium cobalt oxide (LCO), lithium nickel oxide (LNO), lithium manganese oxide (LMO), lithium iron phosphate (LFP), ternary lithium metal oxide (NCM), or a spinel compound. An electrode slurry for making a negative electrode may include a negative electrode active material, such as graphite or carbon fiber.

The binder may include various materials, such as polyvinylidene fluoride (PVDF), polymethylmethacrylate, polyacrylonitrile, polyethylene, and/or related polymers or copolymers.

The solvent may include N-methyl-2-pyrrolidone (NMP) or water. The electrode slurry 142 is not limited to the materials described above, and may include various types of materials. For example, the solvent may correspond to a material that may be dried by a heating gas.

The dryer 110 may perform a drying process of drying the electrode slurry 142 by removing a solvent in the electrode slurry 142. The dryer 110 may be designed to allow the substrate 130 to slide through the interior of the dryer 110.

In some embodiments, the dryer 110 may include an inlet 112a through which the substrate 130 is pulled in, and may include an outlet 112b through which the substrate 130 is pulled out. The inside of the dryer 110 may include the chamber 112 in which the electrode slurry 142 is dried, may include the nozzle 114 connected to the chamber 112 for spraying gas into the chamber 112 to dry the electrode slurry 142, may include a nozzle plate provided at an outlet of the nozzle 114 and having a plurality of perforations for discharging the gas sprayed from the nozzle 114 toward the substrate 130 (or the electrode slurry 142), and may include the discharger 116 for discharging the gas used for drying the electrode slurry 142 to the outside of the chamber 112

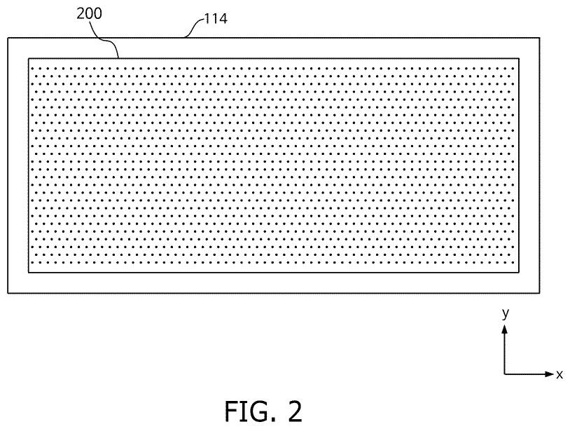

The dryer 110 is not limited to illustration of FIG. 1, and any number of chambers, nozzles, dischargers, and so on may be provided at any position. Furthermore, the nozzle plate provided at an outlet of the nozzle 114 and having a plurality of perforations is described in detail below with reference to FIGS. 2, 6, and 7.

In some embodiments, the discharger 116 may face the nozzle 114 about the substrate 130. In some embodiments, the discharger 116 may be separated from the nozzle 114 to face the nozzle 114 with the substrate 130 interposed therebetween.

For example, in a state where the nozzle 114 is positioned on (e.g., above) an upper side (a +z direction) of the substrate 130, the discharger 116 may be positioned on (e.g., below) a lower side (a −z direction) of the substrate 130. In a state where the nozzle 114 is positioned on or below the lower side (the −z direction) of the substrate 130, the discharger 116 may be positioned on or above the upper side (the +z direction) of the substrate 130. By arranging the nozzle 114 and the discharger 116 to face each other about the substrate 130 (e.g., with the substrate 130 therebetween), the flow of gas may be more precisely controlled, and the drying amount of the solvent may be precisely controlled.

In other embodiments, the nozzle 114 and the discharger 116 may be positioned in the same direction (for example, on or above an upper side of the substrate 130) about the substrate 130.

The supply pipes 122 and 124 may supply gas to the nozzle 114. Although FIG. 1 illustrates two supply pipes 122 and 124 for each nozzle, the present disclosure is not limited thereto, and any number of supply pipes may be connected to each nozzle.

The supply pipes 122 and 124 may be connected to a gas-generating device (for example, a hot-air-generating device) for drying an electrode slurry, and the amount of gas transferred to the supply pipes 122 and 124 and/or the amount of gas supplied to the nozzle 114 may be adjusted by using a pump, a fan, a valve, or so on. The supply pipes 122 and 124 may each supply gas (for example, hot air, steam, or so on) according to different heat sources.

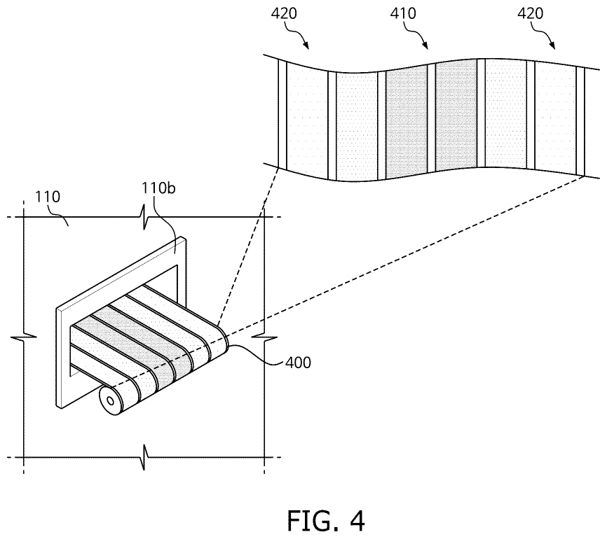

The densimeter 160 may measure the density of slurry for each region on the substrate 130 after the drying process. In some embodiments, the densimeter 160 may be provided in a direction of the dryer outlet 110b, and may be a radiation-type sensor (for example, a B-ray sensor). The density of the slurry for each region may be measured for all or part of the substrate 130. For example, the substrate 130 may be sequentially divided into stripe regions, and the density of the slurry may be measured for each stripe region. For example, in a state where there are six stripe regions (see FIG. 4), the respective stripe regions may be sequentially defined as region 1 to region 6, and the density of slurry for each region may be measured. The density for each region may be measured in real time or at regular intervals.

After the drying process, the amount of dried solvent evaporated from the electrode slurry 142, and the amount of undried solvent not evaporated, may be determined by using the densimeter 160. The amount of dried solvent and the amount of undried solvent may be determined based on the density of each region on the substrate of the electrode slurry before and after the drying process. In this case, a region on the substrate where the density is measured may be a region (for example, a stripe-shaped region formed in a transfer direction of the substrate) that is vertically divided in the width direction (the x-axis direction) of the substrate 130 at a substantially constant length.

For example, the density of the electrode slurry 142 for each region on the substrate before the drying process may be directly measured by using a separate densimeter at the dryer inlet 110a, or may be determined from constituent materials and a mixing ratio of the electrode slurry. Then, after the drying process, the density of the electrode slurry 142 for each region on the substrate may be measured by using the densimeter 160. Thereafter, based on the change in density of the electrode slurry 142 for each region on the substrate measured/determined before and after the drying process, the amount of dried solvent and the amount of undried solvent for each region may be determined based on the substrate 130 extracted from the dryer outlet 110b.

In other embodiments, the amount of dried solvent or the amount of undried solvent for each region may be measured through thickness measurement, spectroscopic analysis, and so on before and after the drying process.

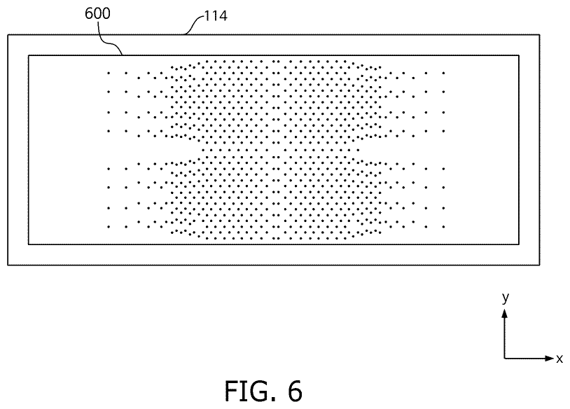

Thereafter, as the number of perforations on the nozzle plate is determined based on the amount of undried solvent for each region, the solvent of the electrode slurry 142 may be dried substantially uniformly on the substrate 130. This is described in detail below with reference to FIGS. 6 to 10.

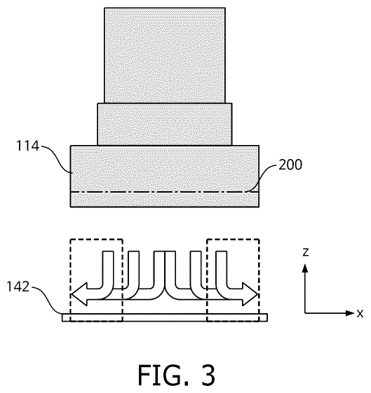

FIG. 2 illustrates the nozzle plate 200 according to one or more embodiments of the present disclosure, and FIG. 3 illustrates a flow of the gas discharged from the nozzle 114 including the nozzle plate 200 of FIG. 2 toward the electrode slurry 142 on the substrate 130. The nozzle plate 200 may be provided at an outlet of the nozzle 114, and a plurality of perforations indicated by dark dots may be formed in a certain pattern in the nozzle plate 200. The nozzle plate 200 may be inserted into the outlet of the nozzle 114 as illustrated in FIG. 3, or may be installed at an end of the outlet of the nozzle 114 to expose at least a part of the nozzle plate 200 to the outside.

As illustrated in FIG. 2, perforations may be formed in the nozzle plate 200 so that the number of perforations per unit area may be substantially constant. As illustrated in FIG. 3, the gas discharged toward the substrate 130 may be discharged at a substantially constant flow rate per unit area. Sizes of arrows illustrated in FIG. 3 indicate flow rates of gas, and the arrows of the same size mean that gas of the same flow rate is discharged per unit area.

As may be seen from the arrows indicated in a width direction (an x-axis direction) of the substrate, the gas discharged from a reference nozzle plate 200 in the width direction (the x-axis direction) may collide with the electrode slurry 142 on the substrate 130, and then may move to the edge portions on both sides of a central portion of the substrate 130 or the electrode slurry 142. In such a process, it can be seen that the flow rate of gas increases at the edge portions in the width direction. In some embodiments, in FIG. 3, it can be seen that arrows of the same size overlap each other at the edge portions in the width direction (see dotted lines). In some embodiments, the slurry applied to a central portion of the substrate is not dried sufficiently compared to an edge portion of the substrate in a width direction, and the performance of battery cells may be reduced due to migration imbalance of a binder.

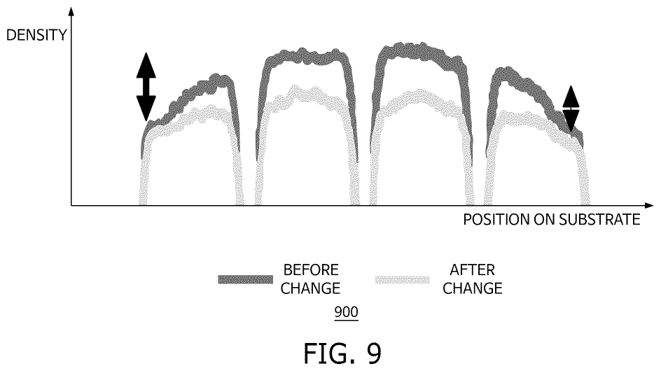

In some embodiments, it may be suitable to substantially uniformly apply the electrode slurry prepared in a mixing process onto a substrate (for example, Cu foil), and to increase solvent-drying uniformity in a process of evaporating the solvent while the substrate passes through a dryer. A difference in the solvent-drying uniformity in the width direction of the substrate may cause quality (peel strength) reduction, and may cause cell performance differences, due to the migration imbalance of a binder. An internal airflow distribution and drying efficiency may change depending on various factors, such as a structure of an internal circulation path of a dryer, a position of an exhaust hole, a coating method, and an overall width of the substrate. This may cause a drying variation in a width direction of a substrate, and may reduce process margins or coating speeds. Even by controlling a solvent-drying variation under production conditions, there may be limitations due to differences in level of folding of the substrate due to heat strain distribution and stress occurring in the width direction of the substrate. According to some embodiments of the present disclosure, by controlling a gas flow in a dryer by an arrangement of perforations (for example, see arrows illustrated in FIG. 9), a solvent is dried substantially uniformly over the entire region of the substrate. In the present disclosure, the arrangement of perforations is used as a concept that includes positions of the perforations, sizes of the perforations, the number of perforations, and so on.

FIG. 4 illustrating a degree of drying of the substrate 400 dried by the nozzle 114 including the nozzle plate 200 of FIG. 2. The substrate 400 may be dried by the dryer 110, and then may be pulled out of the dryer outlet 110b. In this case, a slurry-uncoated region on the substrate 400 corresponds to a slurry-uncoated region caused by a stripe-coating process.

As illustrated in FIG. 3, as the flow of gas is deflected toward an edge portion in a width direction on the substrate 130, the amount of undried solvent in a central portion 410 may be relatively great (indicated by a dark color), and the amount of dried solvent in an edge portion 420 may be relatively small (indicated by a light color). For example, there may be a problem in that the amount of dried solvent included in the slurry is changed depending on positions of the slurry in a base portion. The problem may occur not only in the stripe-coating process illustrated in FIG. 4, but also in various coating methods.

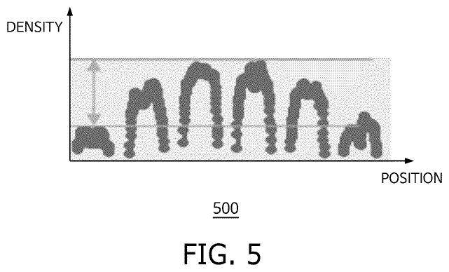

FIG. 5 illustrates a graph 500 obtained by measuring the density of slurry for each region on the dried substrate by using the nozzle 114 including the nozzle plate 200 of FIG. 2. In measuring the density, a section without density data in the graph 500 may correspond to a section corresponding to a region where slurry is not applied. As illustrated FIG. 5, the density (mg/cm²) of the slurry decreases toward an

edge portion in a width direction of the substrate, and increases toward a central portion in the width direction. It may be seen that the amount of undried solvent is reduced toward the edge portion in the width direction of the substrate, and the amount of undried solvent is increased toward the central portion in the width direction of the substrate.

For example, density may be measured by a coating weight measurement system. The coating weight measurement system may indirectly measure a quantitative difference before and after coating (e.g., weight=weight after coating−weight before coating). A B-ray sensor capable of measuring both an object and a surrounding air layer may be used to calculate a coating weight, and may perform high-speed scanning in a TD direction with a position resolution of about 1/1000mm of a servo motor.

FIG. 6 illustrates a nozzle plate 600 according to one or more embodiments of the present disclosure. The nozzle plate 600 may be provided at an outlet of the nozzle 114, and a plurality of perforations may be formed in a certain pattern in the nozzle plate 600.

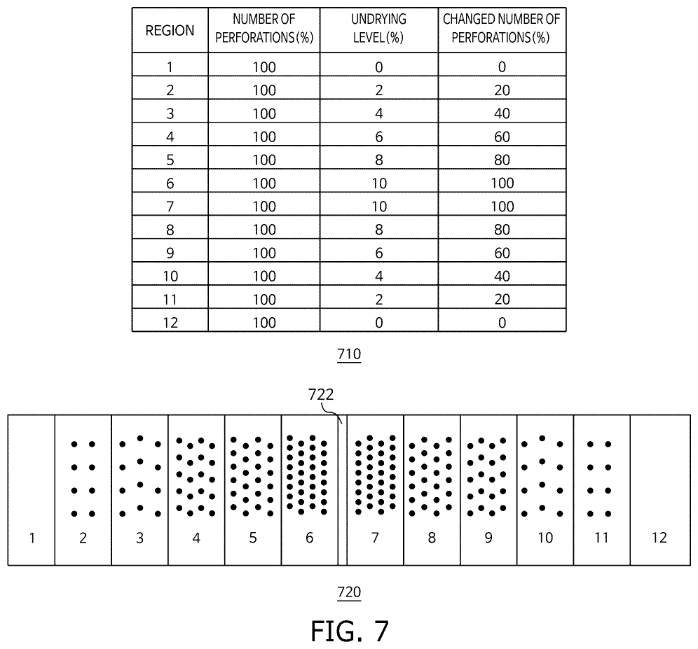

In some embodiments, a plate region of the nozzle plate 600 may have a plurality of plate sub-regions having boundary lines in a movement direction, or in a longitudinal direction (the y-axis direction), of a substrate (see FIG. 7).

In some embodiments, as illustrated in FIG. 6, the number of perforations formed in the plate sub-region corresponding to a central portion of the substrate in a width direction may be greater than the number of perforations formed in the plate sub-regions corresponding to edge portions of the substrate in the width direction. In some embodiments, compared to a case where perforations of the same number per unit area are formed in all regions, the amount of gas discharged toward the central portion of the substrate increases, and the amount of gas discharged toward the edge portion of the substrate decreases. As a result, it may be possible to solve the problem that the amount of undried solvent in the central portion of the substrate after the drying process is greater than the amount of undried solvent in the edge portion of the substrate, and a regional variation in the amount of undried solvent may be reduced.

In other embodiments, to solve the problem that the amount of undried solvent in the central portion of the substrate after the drying process is greater than the amount of undried solvent in the edge portion of the substrate, sizes of the perforations formed in a plate region corresponding to the central portion of the substrate in the width direction may be greater than sizes of the perforations formed in a plate region corresponding to the edge portion of the substrate in the width direction.

In some embodiments, the perforations formed in the nozzle plate 600 may be positioned in a line-symmetrical pattern. For example, perforations may be formed in a line-symmetrical pattern around the x-axis or y-axis center line of the nozzle plate 600.

The nozzle plate 600 illustrated in FIG. 6 may be determined based on the amount of undried solvent on the substrate after the drying process. For example, the number of perforations formed on each plate region may be proportional to the amount of undried solvent in a substrate region corresponding to each plate sub-region.

FIG. 7 illustrates a method of determining the number of perforations of the nozzle plate 720, according to one or more embodiments of the present disclosure.

A table 710 of FIG. 7 shows an example in which, after drying the electrode slurry by using the existing nozzle plate having perforations of the same number per plate sub-region, the number of perforations for each plate sub-region of the nozzle plate 720 may be determined based on the amount of undried solvent for each substrate region corresponding to the plate sub-region. The amount of undried solvent may be calculated by a densimeter based on the change in density of slurry for each region formed on the substrate before and after a drying process.

In some embodiments, the number of perforations may be determined by applying a ratio proportional to the amount of undried solvent to the total number of candidate perforations in the plate sub-region.

For example, one plate region may have 12 plate sub-regions (e.g., a first plate sub-region to a twelfth plate sub-region). An undried level of the slurry of a substrate region corresponding to each plate sub-region may be measured. For example, the plate sub-region may correspond to a stripe region of the substrate. For example, combined two plate sub-regions may correspond to one stripe region, and 12 plate sub-regions may correspond to a total of six stripe regions. In other embodiments, one plate sub-region may correspond to one stripe region, and in this case, 12 plate sub-regions may correspond to a total of 12 stripe regions. In one or more other embodiments, 6 plate sub-regions may correspond to 1 stripe region, and in this case, 12 plate sub-regions may correspond to 2 stripe regions. In this way, the plate sub-region and the stripe region may have a 1:1 or N:1 correspondence relationship (N is a natural number).

As illustrated in FIG. 7, because the level of undried solvent in the sixth plate sub-region and the seventh plate sub-region is the highest at about 10%, the number of perforations in the sixth plate sub-region and the seventh plate sub-region may correspond to about 100% (32 perforations) of a total number of candidate perforations.

Thereafter, the number of perforations may be determined in the same manner for sub-regions that are different based on the amounts of undried solvent in the sixth plate sub-region and the seventh plate sub-region.

For example, the level of undried solvent in the fifth plate sub-region is about 8%, which corresponds to about 80% of the level of dried solvent in the sixth plate sub-region. In some embodiments, the number of perforations in the fifth plate sub-region may be determined to be about 80% (e.g., 24 or 25 perforations corresponding to about 80% of the total number of candidate perforations) of the number of perforations in the sixth plate sub-region.

Furthermore, the level of undried solvent in the fourth plate sub-region is about 6%, which corresponds to about 60% of the level of dried solvent in the sixth plate sub-region. In some embodiments, the number of perforations in the fourth plate sub-region may be determined to be about 60% (e.g., 19 or 20 perforations corresponding to about 60% of the total number of candidate perforations) of the number of perforations in the sixth plate sub-region. The number of perforations in other plate sub-regions of the nozzle plate 720 may be determined in the same manner as described above.

In other embodiments, sizes of perforation may be determined by applying a ratio that is proportional to the amount of undried solvent to an area of a candidate perforation in a plate region. For example, the numbers of perforations in respective regions of the nozzle plate 720 may be equal to each other, the total perforation area of the fourth plate sub-region of the nozzle plate 720 may be determined to be about 60% of the total perforation area of the sixth plate sub-region, and positions of the perforations may be the same as each other.

The number or regions and areas of the regions may be randomly determined. In FIG. 7, for each of 12 plate sub-regions in the plate, the amount of undried solvent is measured, and the number of perforations in the plate sub-regions is determined, but the present disclosure is not limited thereto.

Positions of the perforations may be determined to be positions that are selected to maintain a substantially constant distance between the perforations. In some embodiments, gas may be sprayed evenly over the entire region of the substrate.

In some embodiments, as the electrode slurry is applied on the substrate by a stripe-coating process, a sub-region of the nozzle plate 720 corresponding to a substrate region (an uncoated region) where there is no electrode slurry is separately generated, and perforations may not be formed in the generated sub-region. In some embodiments, it is possible to reduce or prevent the likelihood of a substrate folding phenomenon worsening due to heat shrinkage caused by a large amount of heat being applied to a section where the electrode slurry is not applied.

For example, a non-perforated sub-region 722 of the nozzle plate 720 may be a portion corresponding to a region of the substrate where there is no electrode slurry. In some embodiments, the substrate corresponding to the nozzle plate 720 may be coated with electrode slurry with two stripes. In another example, in a state where the electrode slurry is applied to six stripes, as illustrated in FIG. 4, five non-perforated sub-regions in which no perforations are formed may be formed in the nozzle plate 720.

After the number of perforations in each sub-region is determined, the existing nozzle plate may be repositioned with a new nozzle plate (e.g., the nozzle plate 720). A process of measuring the amount of undried solvent and replacing the nozzle plate based on this may be performed at intervals (e.g., predetermined intervals) or as suitable.

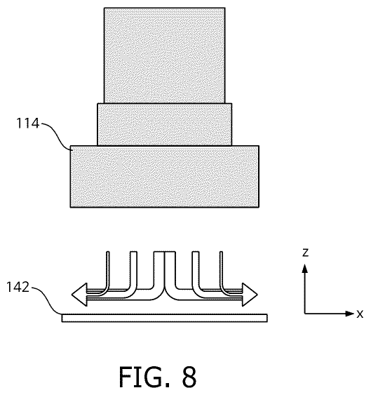

FIG. 8 illustrates a flow of gas discharged from the nozzle 114 including the nozzle plate 600 of FIG. 6 toward the substrate 130.

As the number of perforations formed in a plate region corresponding to a central portion of a substrate in a width direction is greater than the number of perforations formed in a plate region corresponding to an edge portion of the substrate in the width direction, more gas may be discharged toward the central portion of the substrate 130 as compared to the edge portion of the substrate 130, with respect to the width direction.

As illustrated in FIG. 8, it may be seen that a size (width) of an arrow proportional to a flow rate of gas discharged toward the central portion of the substrate 130 in the width direction is greater than a size of an arrow proportional to a flow rate of gas discharged toward an edge portion of the substrate 130 in the width direction.

In some embodiments, even in a state where the gas discharged toward the central portion of a reference nozzle plate (with respect to a width direction/the x-axis direction) collides with the central portion of the electrode slurry 142 formed on the substrate 130, and then moves to edge portions on both sides of the central portion, the total flow rate of gas moving to the edge portions may be reduced as compared to the flow rate illustrated in FIG. 3. In some embodiments, the electrode slurry 142 may be dried substantially uniformly in the width direction.

FIG. 9 illustrates a graph 900 obtained by measuring the density of slurry for each region on a substrate according to the type of nozzle plate.

In the graph 900, a portion where there is no density data, or where the density is 0, may correspond to a slurry-uncoated region caused by a stripe-coating process. In a state where the stripe-coating process is used, the density of slurry for each region may correspond to the density of slurry for each stripe region. Although FIG. 9 illustrates slurry densities measured for four stripe regions, but the number of stripe regions may be changed. Six stripe regions may be formed as illustrated in FIG. 4, and the slurry density for each of the six stripe regions may be measured. In this case, six density graphs for each region of the slurry may be displayed.

The density of slurry for each region may be measured to correspond to a plate sub-region. For example, in response to a case where there are 12 plate sub-regions, as illustrated in FIG. 7, the slurry density of a substrate region corresponding to the plate sub-region may be measured. In this case, the density graph of slurry for each region may be displayed as 12.

In a state where a substrate is dried by using the nozzle 114 including the nozzle plate 200 of FIG. 2 (before the number of perforations is changed), a difference in density of slurry for each region between a central portion and an edge portion of the substrate in a width direction may be relatively increased, and there may be a great difference in the degree of drying of a solvent for each stripe region.

In some embodiments, in a state where a substrate is dried using the nozzle 114 including the nozzle plate 600 of FIG. 6 (after the number of perforations is changed), the difference in density of slurry for each region between the central portion and the edge portion of the substrate in the width direction may be relatively reduced, and there may be a small difference in the degree of drying of a solvent for each region.

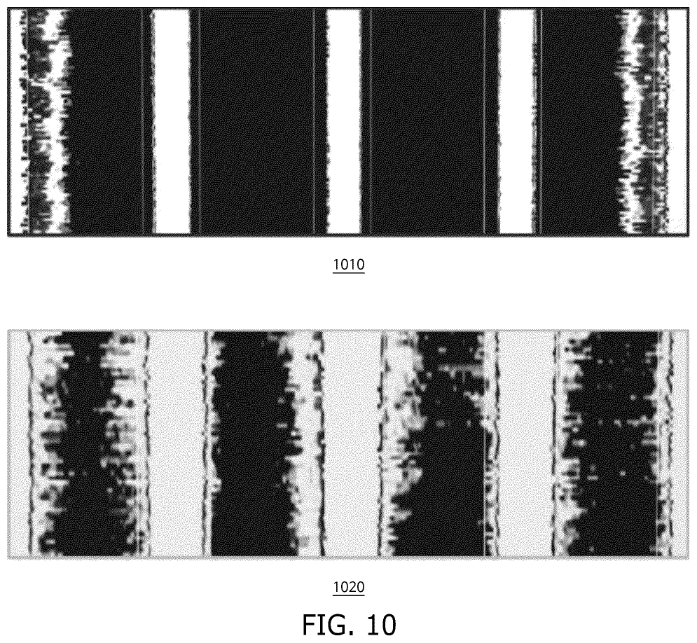

FIG. 10 illustrates views of color maps associated with the density of slurry for each region on a substrate according to the type of nozzle plate.

It may be seen that, in a first color map 1010 associated with a substrate dried by using the nozzle 114 including the nozzle plate 200 of FIG. 2, there is a relatively great difference in respective densities of slurry for each region between a central portion and an edge portion of the substrate in a width direction. In some embodiments, there is a relatively great difference between the density of slurry corresponding to an inner stripe region and the density of slurry corresponding to an outer stripe region. In the color maps, it may be seen that there is a great difference between a color indicating the two inner stripe regions and a color indicating two outer stripe regions.

In contrast to this, it may be seen that, in a second color map 1020 associated with a substrate dried by using the nozzle 114 including the nozzle plate 600 of FIG. 6, respective differences in density of slurry for the regions between a central portion and an edge portion of the substrate in a width direction is reduced. In some embodiments, there is less difference between the density of slurry corresponding to an inner stripe region and the density of slurry corresponding to an outer stripe region. It may be seen from the color maps that there is a less difference between the color indicating two inner stripe regions and the color indicating two outer stripe regions.

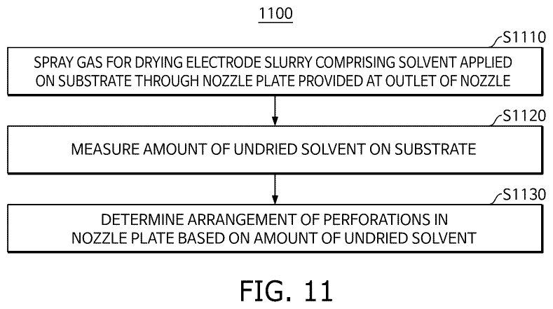

FIG. 11 illustrates a flowchart showing an electrode-slurry-drying method 1100 for a secondary battery, according to one or embodiments of the present disclosure. The electrode-slurry-drying method 1100 may be performed by the electrode-slurry-drying device described above. The electrode-slurry-drying method 1100 may start by spraying gas for drying an electrode slurry including a solvent applied on a substrate through a nozzle plate provided at an outlet of a nozzle (S1110). In some embodiments, gas supplied from at least one of a plurality of supply pipes for supplying gas according to different heat sources may be sprayed through a nozzle plate.

Thereafter, the amount of undried solvent on the substrate may be measured (S1120). In some embodiments, the amount of undried solvent may be measured by a densimeter based on a change in density of slurry for each region on the substrate. The densimeter used to measure the amount of undried solvent may correspond to a radiation-type sensor.

Thereafter, the arrangement of perforations formed in the nozzle plate may be determined based on the amount of undried solvent (S1130).

In some embodiments, the number of perforations formed on a plate sub-region may be determined to be proportional to the amount of undried solvent in a substrate region corresponding to the plate sub-region. For example, the number of perforations may be determined by applying a ratio that is proportional to the amount of undried solvent to the total number of candidate perforations in the plate sub-region.

In some embodiments, perforations may not be formed on the nozzle plate corresponding to substrate region in which the electrode slurry, which is otherwise applied on the substrate by a stripe-coating process, is not formed.

In some embodiments, positions of the perforations may be determined as positions selected to maintain a substantially constant distance between the perforations.

Thereafter, the nozzle plate may be repositioned with a new nozzle plate having the number and/or positions of the perforations adjusted according to the determined number and/or position of the perforations. Electrode slurry including a solvent applied on a substrate may be dried by a nozzle including a new nozzle plate.

Although the present disclosure has been described with reference to embodiments and drawings illustrating aspects thereof, the present disclosure is not limited thereto. Various modifications and variations may be made by a person skilled in the art to which the present disclosure belongs within the scope of the technical spirit of the present disclosure and the claims and their equivalents, below.

What is claimed is:

1. An electrode-slurry-drying device comprising:
a nozzle configured to spray gas to dry an electrode slurry comprising a solvent applied on a substrate; and
a nozzle plate at an outlet of the nozzle, and defining perforations for discharging the gas toward the substrate,
wherein a number of the perforations is determined based on an amount of undried solvent on the substrate.

2. The electrode-slurry-drying device as claimed in claim 1, wherein the nozzle plate comprises a plate region comprising plate sub-regions, and
wherein respective numbers of ones of the perforations at the plate sub-regions is proportional to respective amounts of the undried solvent in regions of the substrate respectively corresponding to the plate sub-regions.

3. The electrode-slurry-drying device as claimed in claim 2, wherein the respective numbers of the ones of the perforations are determined by applying respective ratios that are proportional to the respective amounts of the undried solvent to a total number of candidate perforations in the plate sub-regions.

4. The electrode-slurry-drying device as claimed in claim 2, wherein a first number of corresponding ones of the perforations in one of the plate sub-regions corresponding to a central portion of the substrate is greater than a second number of corresponding others of the perforations in one of the plate sub-regions corresponding to an edge portion of the substrate.

5. The electrode-slurry-drying device as claimed in claim 1, wherein positions of the perforations are selected to maintain substantially constant distances between the perforations.

6. The electrode-slurry-drying device as claimed in claim 1, wherein the electrode slurry is applied by a stripe-coating process, and wherein the perforations are omitted from a portion of the nozzle plate corresponding to a region of the substrate omitting the electrode slurry.

7. The electrode-slurry-drying device as claimed in claim 1, wherein positions of the perforations have a line-symmetrical pattern.

8. The electrode-slurry-drying device as claimed in claim 1, further comprising a densimeter configured to calculate the amount of the undried solvent based on a change in density of the electrode slurry on the substrate for respective regions of the substrate.

9. The electrode-slurry-drying device as claimed in claim 8, wherein the densimeter corresponds to a radiation-type sensor.

10. The electrode-slurry-drying device as claimed in claim 1, further comprising a chamber comprising an inlet through which the substrate is configured to be pulled in, and an outlet through which the substrate is configured to be pulled out, and configured to dry the electrode slurry inside the chamber,
wherein the nozzle is connected to the chamber, and is configured to spray the gas into the chamber, and
wherein the amount of the undried solvent is determined based on the substrate pulled out of the outlet.

11. The electrode-slurry-drying device as claimed in claim 1, wherein the nozzle plate comprises a plate region comprising plate sub-regions, and
wherein an area of the perforations defined in the plate sub-regions is proportional to a corresponding amount of the undried solvent in a region of the substrate corresponding to the plate sub-regions.

12. The electrode-slurry-drying device as claimed in claim 1, further comprising supply pipes configured to supply the gas to the nozzle, and configured to supply the gas according to different heat sources.

13. An electrode-slurry-drying method, the method comprising:
spraying gas for drying an electrode slurry comprising a solvent applied on a substrate through a nozzle plate provided at an outlet of a nozzle;
measuring an amount of undried solvent on the substrate; and
determining an arrangement of perforations in the nozzle plate based on the amount of the undried solvent.

14. The electrode-slurry-drying method as claimed in claim 13, wherein the measuring of the amount of the undried solvent comprises measuring, by a densimeter, the amount of the undried solvent based on a change in density of the electrode slurry on the substrate for respective regions of the substrate.

15. The electrode-slurry-drying method as claimed in claim 14, wherein the densimeter corresponds to a radiation-type sensor.

16. The electrode-slurry-drying method as claimed in claim 13, further comprising:
replacing the nozzle plate with a new nozzle plate having a determined number of perforations; and
drying the electrode slurry by using the nozzle comprising the new nozzle plate.

17. The electrode-slurry-drying method as claimed in claim 13, wherein the nozzle plate comprises a plate region comprising plate sub-regions, and
wherein the determining of the arrangement of the perforations comprises determining respective numbers of the perforations at the plate sub-regions to be proportional to respective amounts of the undried solvent in respective regions of the substrate corresponding to the plate sub-regions.

18. The electrode-slurry-drying method as claimed in claim 17, wherein the determining the respective numbers of the perforations comprises applying respective ratios proportional to the respective amounts of the undried solvent to a total number of candidate perforations in the plate sub-regions.

19. The electrode-slurry-drying method as claimed in claim 13, wherein the determining of the arrangement of the perforations comprises selecting positions of the perforations to maintain substantially constant distances between the perforations.

20. The electrode-slurry-drying method as claimed in claim 13, wherein the spraying the gas comprises spraying the gas supplied from at least one of supply pipes for supplying the gas according to different heat sources through the nozzle plate.
